(19) United States
(12) Patent Application Publication
(10) Pub. No.: US 2026/0147966 A1
(43) Pub. Date: May 28, 2026

(54) METHODS, SYSTEMS, AND MEDIUMS FOR FRACTURING DESIGN OF INFILL WELL BASED ON RECOVERABLE REGION

(71) Applicant: SOUTHWEST PETROLEUM UNIVERSITY, Chengdu (CN)

(72) Inventors: Huiying TANG, Chengdu (CN); Qi RUAN, Chengdu (CN); Chenxi ZHANG, Chengdu (CN); Kaichen LU, Chengdu (CN); Yulong ZHAO, Chengdu (CN); Liehui ZHANG, Chengdu (CN); Feng GE, Chengdu (CN); Jianfa WU, Chengdu (CN); Yong LIU, Chengdu (CN); Bo ZENG, Chengdu (CN); Yi SONG, Chengdu (CN); Deliang ZHANG, Chengdu (CN); Jian ZHENG, Chengdu (CN)

(73) Assignee: SOUTHWEST PETROLEUM UNIVERSITY, Chengdu (CN)

(21) Appl. No.: 19/369,171

(22) Filed: Oct. 24, 2025

(30) Foreign Application Priority Data
Nov. 25, 2024 (CN) 202411687942.1

(51) Int. Cl. G06F 30/28; E21B 43/26; E21B 49/08

(52) U.S. Cl. CPC G06F 30/28; E21B 43/26; E21B 49/08; E21B 2200/20

(57) ABSTRACT

Provided are methods, systems, and mediums for fracturing design of an infill well based on a recoverable region, belonging to the field of unconventional natural gas exploration and development technology. The method includes: constructing a fracturing parameter design model for an infill well in a target block; simulating a production process of an implemented well pattern, and obtaining a pressure field of the infill well before fracturing; performing four-dimensional stress dynamics calculation during a hydrocarbon reservoir production process to obtain a stress evolution result, and updating relevant geological parameters in the fracturing parameter design model infill well according to the stress evolution result; identifying an area of a recoverable region of the infill well in an updated fracturing parameter design model; performing staged fracturing classification for the infill well based on the area of the recoverable region, and designing differentiated fracturing operation parameters for classified multi-stage fractures.

### CROSS-REFERENCE TO RELATED APPLICATIONS

This application claims priority to Chinese Patent Application No. 202411687942.1 filed on Nov. 25, 2024, the entire content of which is hereby incorporated by reference.

### TECHNICAL FIELD

The present disclosure relates to the field of unconventional natural gas exploration and development technology, and in particular, to methods, systems, and mediums for fracturing design of an infill well based on a recoverable region.

### BACKGROUND

In recent years, with declining conventional hydrocarbon resources, the development of unconventional hydrocarbon resources, such as shale gas, has gradually become an important part of the global energy supply. In China, after more than a decade of development, the medium and deep shale gas resources, represented by Changning shale gas, are facing challenges of rapid production decline of gas wells and difficulty in maintaining stable output. To improve the recovery rate and economic benefits, an infill well fracturing technology has become an important topic that needs to be urgently solved. This technology aims to achieve effective utilization of the remaining reserves by drilling new infill wells between existing parent wells and fracturing the new infill wells.

The production of parent wells alters in-situ stress around infill wells, significantly affecting fracture geometry and propagation, which requires in-depth study to improve fracturing effectiveness through fracture optimization design. Currently, the conventional fracturing design of the infill well is mostly carried out by changing different fracturing operation parameters, conducting a large number of numerical simulations, comparing a stimulated reservoir volume under combinations of different operation parameters to obtain optimized fracturing operation parameters of the infill well. Such an approach is computationally intensive, and maximizing the SRV of the infill well often enhances the fracturing performance of the infill well, while fails to optimize the overall productivity of the well group.

### SUMMARY

In response to the above problems, the present disclosure provides methods, systems, and mediums for fracturing design of an infill well based on a recoverable region.

One or more embodiments of the present disclosure provide a method for fracturing design of an infill well based on a recoverable region, comprising:
S1: constructing a fracturing parameter design model for an infill well in a target block;
S2: simulating a production process of an implemented well pattern based on the fracturing parameter design model of the infill well, and obtaining a pressure field of the infill well before fracturing;
S3: performing four-dimensional stress dynamics calculation during a hydrocarbon reservoir production process based on the pressure field to obtain a stress evolution result, and updating relevant geological parameters in the fracturing parameter design model for the infill well according to the stress evolution result;
S4: identifying an area of a recoverable region of the infill well in an updated fracturing parameter design model;
S5: performing staged fracturing classification for the infill well based on the area of the recoverable region, and designing differentiated fracturing operation parameters for classified multi-stage fractures;
criteria for performing staged fracturing classification for the infill well are as follows:
   a fracture stage is classified as Class I fracture stage when: a total recoverable length on both sides of a horizontal fracture stage is larger than or equal to 0.5 times a parent well spacing, and distances from the both sides of the horizontal fracture stage to a boundary of the recoverable region are each larger than or equal to 0.9 times a well spacing;
a fracture stage is classified as Class II fracture stage when: a total recoverable length on both sides of a horizontal fracture stage is larger than or equal to 0.5 times the parent well spacing, and distances from the both sides of the horizontal fracture stage to the boundary of the recoverable region are each larger than or equal to 0.1 times the well spacing;
a fracture stage is classified as Class III fracture stage when: a total recoverable length on both sides of a horizontal fracture stage is less than 0.5 times the parent well spacing, and distances from the both sides of the horizontal fracture stage to the boundary of the recoverable region are each larger than or equal to 0.1 times the well spacing;
when designing the differentiated fracturing operation parameters for the classified multi-stage fractures,
for Class I fracture stages, designing the differentiated fracturing operation parameters to maximize a stimulated reservoir volume (SRV);
for Class II fracture stages, designing the differentiated fracturing operation parameters in combination with temporary plugging; and
for Class III fracture stages, designing the differentiated fracturing operation parameters primarily for fracture containment.

One or more embodiments of the present disclosure provide a system for fracturing design of an infill well based on a recoverable region, comprising:
a model construction module configured to construct a fracturing parameter design model for an infill well in a target block;
a production process simulation module configured to simulate a production process of an implemented well pattern based on the fracturing parameter design model for the infill well, and obtain a pressure field of the infill well before fracturing;
a four-dimensional stress dynamics calculation module configured to perform four-dimensional stress dynamics calculation during a hydrocarbon reservoir production process based on the pressure field to obtain a stress evolution result, and update relevant geological parameters in the fracturing parameter design model for the infill well according to the stress evolution result;
an area calculation module configured to identify an area of a recoverable region of the infill well in an updated fracturing parameter design model;
a fracturing operation parameter design module configured to perform staged fracturing classification for the infill well based on the area of the recoverable region, and design differentiated fracturing operation parameters for classified multi-stage fractures;
criteria for performing staged fracturing classification for the infill well are as follows:
a fracture stage is classified as Class I fracture stage when: a total recoverable length on both sides of a horizontal fracture stage is larger than or equal to 0.5 times a parent well spacing, and distances from the both sides of the horizontal fracture stage to a boundary of the recoverable region are each larger than or equal to 0.9 times the parent well spacing;
a fracture stage is classified as Class II fracture stage when: a total recoverable length on both sides of a horizontal fracture stage is larger than or equal to 0.5 times the parent well spacing, and distances from the both sides of the horizontal fracture stage to the boundary of the recoverable region are each larger than or equal to 0.1 times the parent well spacing;
a fracture stage is classified as Class III fracture stage when: a total recoverable length on both sides of a horizontal fracture stage is less than 0.5 times the parent well spacing, and distances from the both sides of the horizontal fracture stage to the boundary of the recoverable region are each larger than or equal to 0.1 times the parent well spacing;
when designing the differentiated fracturing operation parameters for the classified multi-stage fractures,
for Class I fracture stages, designing the differentiated fracturing operation parameters to maximize a stimulated reservoir volume (SRV),
for Class II fracture stages, implementing temporary plugging; and
for Class III fracture stages, designing the differentiated fracturing operation parameters primarily for fracture containment.

One or more embodiments of the present disclosure provide a non-transitory computer-readable storage medium storing computer programs, wherein the computer programs are executed by a processor to implement the above method for fracturing design of an infill well based on a recoverable region.

### BRIEF DESCRIPTION OF THE DRAWINGS

In order to more clearly illustrate the technical solutions in the embodiments of the present disclosure or in the prior art, the accompanying drawings that are to be used in the description of the embodiments or the prior art will be briefly described below, and it will be apparent that the accompanying drawings in the following description are only a Obviously, the following description of the accompanying drawings is only some of the embodiments of the present disclosure, for the person of ordinary skill in the field, in the premise of not paying creative labor, but also may be based on these drawings to obtain other drawings.

FIG. 1 is a cross-sectional diagram of a pressure-horizontal stress difference profile in a vertical wellbore direction of a parent well in a specific embodiment;

FIG. 2 is a comparative verification diagram of a simulated fracture network and monitoring results obtained using a holographic electromagnetic manner in a specific embodiment;

FIG. 3 is a pressure field diagram of an infill well before fracturing in a specific embodiment;

FIG. 4 is an updated distribution map of a maximum horizontal principal stress in a specific embodiment;

FIG. 5 is a schematic diagram of a depleted region in a specific embodiment;

FIG. 6 is a schematic diagram of a boundary of a recoverable region on both sides drawn based on pressure depletion in a specific embodiment;

FIG. 7 is a diagram of pre-optimization (left) and post-optimization (right) pressure fields at a final production stage of a well group in a specific embodiment;

FIG. 8 is a comparative diagram of cumulative gas productions of a well group before and after optimization in a specific embodiment, wherein FIG. 8(a) is a comparative diagram of cumulative gas productions for each well, and FIG. 8(b) is a comparative diagram of cumulative gas productions for the well group.

### DETAILED DESCRIPTION

The present disclosure is further described below in connection with the accompanying drawings and embodiments. It should be noted that the embodiments and the technical features in the embodiments in the present disclosure may be combined with each other without conflict. It should be noted that, unless otherwise indicated, all technical and scientific terms used in the present disclosure have the same meanings as are commonly understood by one of ordinary skill in the art to which the present disclosure belongs. The present disclosure discloses that the use of the words “includes” or “comprises” and similar words means that the components or objects appearing in front of the word encompass the components or objects appearing after the word and their equivalents, and do not exclude other components or objects.

In some embodiments, the present disclosure provides a method for fracturing design of an infill well based on a recoverable region, which may be executed by a processor. The processor may include a central processing unit (CPU), an application-specific integrated circuit (ASIC), an application-specific instruction set processor (ASIP), a graphics processing unit (GPU), a physical operations processing unit (PPU), a digital signal processor (DSP), a reduced instruction set computer (RISC), etc., or any combination thereof.

In some embodiments, a memory may be integrated into the processor. The memory may be used to store data, instructions, or any other information. For example, the memory may store current wellbore data, historical wellbore data, historical production data, etc. The memory may include a mass storage, etc.

In some embodiments, the method for fracturing design of an infill well based on a recoverable region includes:
S1: constructing a fracturing parameter design model for the infill well in a target block.

The target block may be a region where the infill well needs to be set. The infill well may be a new well added to an existing parent well pattern. A parent well (also referred to as an old well) may be an original well that has been put into production.

The fracturing parameter design model for the infill well is configured to generate an area of a recoverable region of the infill well.

In a specific embodiment, the fracturing parameter design model for the infill well includes a reservoir property model, a geomechanical model, a natural fracture model, and a parent well pattern model.

In some embodiments, the reservoir property model includes porosity, permeability, saturation, etc., the geomechanical model includes Young's modulus, Poisson's ratio, triaxial principal stresses, stress orientation, pore pressure, etc., the natural fracture model includes fracture distribution, fracture dimension, fracture orientation, etc., and the parent well pattern model includes parent well trajectories and simulated fracture network results.

The parent well trajectories may be drilling trajectories of the parent well in the underground reservoir. The simulated fracture network results may be simulated results of a reservoir fracture network formed after the fracturing operation of the parent well.

The fracturing parameter design model for the infill well established by the above embodiments can take into account the influence of a naturally fractured reservoir on the volumetric fracturing of the infill well due to long-term exploitation, and accurately describe the real state of the shale reservoir before fracturing of the infill well.

In a specific embodiment, when constructing the fracturing parameter design model for the infill well, the processor first constructs the reservoir property model and the geomechanical model based on reservoir properties (e.g., the porosity, permeability, saturation, etc.) and geomechanical parameters (e.g., the Young's modulus, Poisson's ratio, triaxial principal stresses, stress orientation, pore pressure, etc.), and then imports natural fracture data (e.g., the fracture distribution, fracture dimension, fracture orientation, etc.) into the reservoir property model and the geomechanical model, and simulates the fracture network of the parent well with constraints of monitoring results of a holographic electromagnetic manner. The natural fracture may be a naturally occurring fracture in the reservoir. The holographic electromagnetic manner can dynamically monitor the fracture condition of the reservoir, and the monitoring results may include the fracture distribution, the fracture orientation, and the fracture dimension.

S2: simulating a production process of an implemented well pattern based on the fracturing parameter design model for the infill well, and obtaining a pressure field of the infill well before fracturing.

The pressure field may characterize a distribution of fluid pressure over the reservoir space. In some embodiments, the pressure field may be represented by a mathematical model or a visual graph (e.g., a pressure contour plot or a pressure cloud map, etc.).

In some embodiments, the implemented well pattern may be a well pattern composed of parent wells.

In a specific embodiment, the S2 further includes: obtaining historical production data of the implemented well pattern, calibrating a simulated production process using the historical production data to obtain a calibration result, and adjusting the fracturing parameter design model for the infill well based on the calibration result.

In some embodiments, the production data may include a daily hydrocarbon production, a cumulative hydrocarbon production, and a usage time of the parent well.

In some embodiments, the processor adjusts the fracturing parameter design model for the infill well based on the calibration result includes: adjusting relevant geological parameters in the fracturing parameter design model for the infill well based on the discrepancy between the production data obtained from the simulated production process and the historical production data. For example, if the daily hydrocarbon production obtained from the simulated production process is less than the daily hydrocarbon production in the historical production data, the porosity or the permeability may be adjusted upward.

The relevant geological parameters may include the porosity, the permeability, the saturation, the Young's modulus, the Poisson's ratio, the triaxial principal stresses, the stress orientation, and the pore pressure.

S3: performing four-dimensional stress dynamics calculation during a hydrocarbon reservoir production process based on the pressure field to obtain a stress evolution result, and updating relevant geological parameters in the fracturing parameter design model for the infill well according to the stress evolution result.

The hydrocarbon reservoir production process may be a full-cycle production process of oil and gas.

The stress evolution result may characterize dynamics of the pressure field of the reservoir during the production process or the fracturing process.

It should be noted that the four-dimensional stress dynamics calculation utilizes the single medium seepage model and the finite element model to perform flow-solid coupling to get a stress tensor and a pore pressure distribution of each time step, and the specific calculation manner will not be repeated here.

In the present disclosure, the volumetric fracturing analysis of the infill well based on the result of the four-dimensional stress dynamics calculation is able to solve the problem of unclear understanding regarding the morphology of the complex fractures generated by the fracturing of the infill well.

S4: identifying an area of a recoverable region of the infill well in an updated fracturing parameter design model.

The recoverable region of the infill well (also referred to as the recoverable region) may be a region of hydrocarbon that may be effectively recovered by the infill well.

In a specific embodiment, the processor identifies depleted boundaries of two nearest parent wells relative to the infill well using a pressure depletion threshold, a region between the depleted boundaries of the two parent wells being an undepleted region, and calculates the area of the recoverable region of the infill well based on the undepleted region. It should be noted that the pressure depletion threshold is determined by a pressure depletion profile.

The pressure depletion profile may be a spatial distribution curve used to characterize the pressure around the parent well in the reservoir. The pressure depletion threshold may be a threshold for identifying a pressure depletion magnitude at the depleted boundaries of the parent well. The region between the depleted boundaries of the parent well and the parent well is a depleted region of the parent well. The undepleted region refers to an undepleted region within the reservoir.

In some embodiments, the recoverable region of the infill well is within the undepleted region, and the area of the recoverable region of the infill well may be obtained by calculating a product of a length of the infill well in the horizontal direction and a width of the undepleted region.

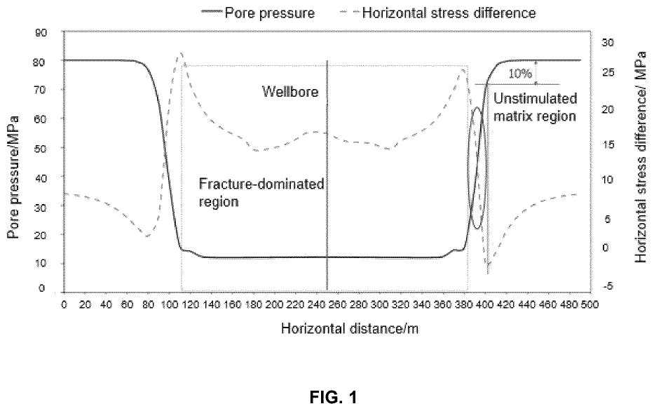

FIG. 1 is a cross-sectional diagram of a pressure-horizontal stress difference profile in a vertical wellbore direction of a parent well in a specific embodiment.

In a specific embodiment, a pressure-horizontal stress difference profile (also referred to as a pressure depletion profile) in a vertical wellbore direction for a parent well in a well group in a shale gas reservoir is shown in FIG. 1. Referring to FIG. 1, distinct pressure depletion partitions are evident, such as a fracture-dominated region, an unstimulated matrix region (also referred to as the undepleted region), and an intermediate transitional region between the fracture-dominated region and the unstimulated matrix region. The intermediate transitional region is not recognized as the undepleted region because of the extreme pressure gradient and drastic change in stress, reversal of the horizontal stress orientation, and complex and uncontrollable fracture expansion (with a high fracture containment risk, etc.) in this region.

In some embodiments, as shown in FIG. 1, a pressure depletion threshold of 10% may be determined based on the pressure depletion profile, i.e., a region with a pressure depletion magnitude less than 10% is the undepleted region.

S5: performing staged fracturing classification for the infill well based on the area of the recoverable region, and designing differentiated fracturing operation parameters for classified multi-stage fractures.

The fracture stages may be different regions in the fracturing operation. The design of the differentiated fracturing operation parameters may be a design of fracturing operation parameters for fracture stages of different classes.

In a specific embodiment, the criteria for performing staged fracturing classification for the infill well are as follows:
a fracture stage is classified as Class I fracture stage when: a total recoverable length on both sides of a horizontal fracture stage is larger than or equal to 0.5 times a parent well spacing, and distances from the both sides of the horizontal fracture stage to a boundary of the recoverable region are each larger than or equal to 0.9 times a well spacing;
a fracture stage is classified as Class II fracture stage when: a total recoverable length on both sides of a horizontal fracture stage is larger than or equal to 0.5 times the parent well spacing, and distances from the both sides of the horizontal fracture stage to the boundary of the recoverable region are each larger than or equal to 0.1 times the well spacing; and
a fracture stage is classified as Class III fracture stage when: a total recoverable length on both sides of a horizontal fracture stage is less than 0.5 times the parent well spacing, and distances from the both sides of the horizontal fracture stage to the boundary of the recoverable region are each larger than or equal to 0.1 times the well spacing.

In some other embodiments, the criteria for performing staged fracturing classification for the infill well are as follows:
a total recoverable length on both sides of a horizontal fracture stage is denoted as L, and distances from the both sides of the horizontal fracture stage to a boundary of the recoverable region are denoted as L₁ and L₂, respectively, and a parent well spacing is denoted as S;
a fracture stage is classified as Class I fracture stage when: L is greater than or equal to 0.5 S and a difference between L₁ and L₂ is less than 0.1 L;
a fracture stage is classified as Class II fracture stage when: L is less than 0.5 S and the difference between L₁ and L₂ is less than 0.1 L;
a fracture stage is classified as Class III fracture stage when: L is less than 0.5 S and the difference between L₁ and L₂ is greater than 0.1 L.

The parent well spacing may be a spacing between the horizontal fracture stage and the nearest parent well. The total recoverable length is a length of a recoverable region on two sides of the horizontal fracture stage in a horizontal direction. The distance between one side of the horizontal fracture stage and the boundary of the recoverable region refers to a distance between one side of the horizontal fracture stage and the boundary of the recoverable region close to the side.

In a specific embodiment, designing the differentiated fracturing operation parameters for the classified multi-stage fractures includes following steps.

For Class I fracture stages, designing the differentiated fracturing operation parameters to maximize a stimulated reservoir volume (SRV). Maximizing the stimulated reservoir volume may be to form the largest possible and effective fracture network in the reservoir.

For Class II fracture stages, designing the differentiated fracturing operation parameters in combination with temporary plugging. The temporary plugging may be plugging formed fractures by temporary plugging agents (e.g., temporary plugging balls, fibers, particles, etc.), forcing a fracturing fluid to shift to under-stimulated regions and enhancing the overall stimulation effectiveness.

For Class III fracture stages, designing the differentiated fracturing operation parameters primarily for fracture containment. The fracture containment may include controlling the operation parameters or adding fracture containment materials to limit excessive fracture propagation and prevent communication with the fracture of neighboring wells.

In some embodiments, the processor may determine a confidence map of the target block based on current wellbore data, historical wellbore data, the natural fracture model, the reservoir property model, and the geomechanical model, and determine, based on the confidence map, the recoverable region of the infill well and the area of the recoverable region of the infill well. More descriptions regarding the target block, the natural fracture model, the reservoir property model, the recoverable region of the infill well, and the area of the recoverable region of the infill well may be found in the description above.

The current wellbore data refers to wellbore data associated with the parent well. In some embodiments, the wellbore data may include a wellbore location and a dimension. The dimension includes a length, a depth, a width, a slope, etc., of the wellbore.

The historical wellbore data refers to historical data related to the production or operations of the parent well. In some embodiments, the historical wellbore data may include historical production of the parent well and historical fracturing operation data.

In some embodiments, the processor may obtain the current wellbore data and the historical wellbore data through the memory.

The confidence map may characterize confidences of different locations within the target block that may be considered as the recoverable region for the infill well. In some embodiments, the confidence map may be represented by a three-dimensional map and divided into a plurality of sub-regions labeled with a confidence (e.g., 0-1) for each sub-region that may be used as the recoverable region of the infill well.

In some embodiments, the processor may determine, based on the current wellbore data, the historical wellbore data, the natural fracture model, the reservoir property model, and the geomechanical model, a confidence map corresponding to the target block that includes a plurality of sub-regions through a confidence determination model. The sub-regions are divided by the confidence determination model.

In some embodiments, the confidence determination model may be a machine learning model, such as one or a combination of Convolutional Neural Networks (CNN) or other customized model structures.

In some embodiments, the processor may train the confidence determination model with a plurality of first training samples with first labels.

In some embodiments, a first training sample may include sample wellbore data and sample historical wellbore data of a sample infill well, a sample natural fracture model, a sample reservoir property model, and a sample geomechanical model of a sample sub-region. A first label includes a sample confidence map labeled with a confidence corresponding to the first training sample.

In some embodiments, the first training sample and the first label may be determined based on historical data. For example, the processor may designate, based on the historical data, a infill well that is successfully placed at a first historical time within the target block as the sample infill well, designate a sub-region in which the sample infill well is located as the sample sub-region, designate wellbore data at the first historical time and historical wellbore data at a second historical time of the sample infill well as the sample wellbore data and the sample historical wellbore data, and designate a historical natural fracture model, a historical reservoir property model, and a historical geomechanical model of the sample sub-region at the first historical time as the first training sample as well. The first historical time is later than the second historical time.

As another example, if the sample infill well is placed successfully and is capable of production, the first label of the sample sub-region in the sample confidence map is labeled with 1. If the sample infill well placement fails or the placement is successful but production is unachievable, the first label of the sample sub-region in the sample confidence map is labeled with 0. The first label of the sub-region in the sample confidence map that does not have an infill well is labeled with 0.

In some embodiments, the processor may input the plurality of first training samples into an initial confidence determination model, obtain an output of the initial confidence determination model, substitute the first labels and the output into a preset loss function, and iteratively update parameters of the initial confidence determination model by gradient descent or other manners according to a value calculated by the loss function. The model training is completed when a preset condition is satisfied, and a trained confidence determination model is obtained. The preset condition may be that the loss function converges or a count of iterations reaches a threshold, etc.

In some embodiments, the processor may determine, based on the confidence map, the recoverable region of the infill well and the area of the recoverable region of the infill well. For example, the processor may identify a sub-region in the confidence map with a confidence greater than a confidence threshold as the recoverable region of the infill well and identify an area of the sub-region as the area of the recoverable region of the infill well. The confidence threshold may be determined based on a manual predetermination or may be determined based on a production difficulty. More descriptions regarding the confidence threshold may be found below.

In some embodiments of the present disclosure, considering the actual situation of the wellbore and the geological conditions of the target block, outputting the confidence map through the machine learning model and determining the recoverable region of the infill well and the area of the recoverable region of the infill well based on the confidence map, the accuracy and efficiency of determining the recoverable region of the infill well and area of the recoverable region of the infill well may be improved.

In some embodiments, the processor may also determine the production difficulty based on the historical wellbore data, the natural fracture model, the reservoir property model, and the geomechanical model, and determine the confidence threshold based on the production difficulty. The processor determines the recoverable region of the infill well and the area of the recoverable region of the infill well based on the confidence threshold and the confidence map.

The production difficulty refers to a difficulty of placing the infill well in the sub-region.

In some embodiments, the processor may construct a regional feature vector based on the historical wellbore data, the reservoir property model, the geomechanical model, and the natural fracture model corresponding to the sub-region, query a vector database for a first feature vector that satisfies a matching condition with the regional feature vector, and determine a production difficulty corresponding to the first feature vector as the production difficulty of the sub-region. The matching condition may include that the similarity between the first feature vector and the regional feature vector is highest. The vector similarity is negatively correlated with a vector distance. The vector distance includes a Euclidean distance, etc.

The processor may determine the production difficulty of each sub-region by the manner described above.

In some embodiments, the processor may construct the vector database (e.g., Milvus or aiss, etc.) based on historical data. The vector database includes a plurality of first feature vectors and a production difficulty corresponding to each first feature vector. For example, the processor may construct the first feature vector based on historical wellbore data of the historical sub-region at the second historical time and a historical reservoir property model, a historical geomechanical model, and a historical natural fracture model at the first historical time, and designate a historical production difficulty at the first historical time as the production difficulty corresponding to the first feature vector.

In some embodiments, the historical production difficulty may be determined based on time and resources spent for placing the infill well, e.g., the production difficulty may be positively correlated to the time and resources spent on the infill well.

In some embodiments, the processor may determine the confidence threshold based on the production difficulty. For example, the processor may query, based on the production difficulty, the first preset table for a confidence threshold corresponding to the production difficulty as the confidence threshold corresponding to the sub-region.

In some embodiments, the first preset table may be preset based on historical experience and may include a plurality of correspondences between the production difficulty and the confidence threshold, wherein the confidence threshold is positively correlated with the production difficulty.

In some embodiments, the processor may determine, based on the confidence threshold corresponding to each sub-region and the confidence map, a sub-region in the confidence map with a confidence greater than the corresponding confidence threshold as the recoverable region of the infill well, and the sub-region area is determined as the area of the recoverable region of the infill well.

In some embodiments of the present disclosure, the confidence threshold for each sub-region may be determined according to the production difficulty, which can then more accurately determine the area of the recoverable region of the infill well, and avoid failure of placing the infill well due to the production difficulty.

In some embodiments, the processor may determine estimated operation data based on candidate operation parameters, the reservoir property model, the geomechanical model, a fracture stage type, and stage-associated parameters, and determine fracturing operation parameters for the multi-fracture stages based on the estimated operation data. The fracturing operation parameters include a first operation parameter, a second operation parameter, and a third operation parameter. The fracture stage type includes a Class I fracture stage, a Class II fracture stage, and a Class III fracture stage.

More descriptions regarding the fracturing operation parameters may be found above.

The first operation parameter refers to a fracturing operation parameter corresponding to the Class I fracture stage. In some embodiments, the first operation parameter may include a cluster count and a fluid intensity, etc. The fluid intensity may be a volume of a fracturing fluid injected per unit wellbore length (per meter).

The second operation parameter refers to a fracturing operation parameter corresponding to the Class II fracture stage. In some embodiments, the second operation parameter may include a cluster count, a fluid intensity, and a temporary plugging agent parameter. The temporary plugging agent parameter includes an injection amount of temporary plugging agent and an injection location.

The third operation parameter refers to a fracturing operation parameter corresponding to the Class III fracture stage. In some embodiments, the third operation parameter may include a cluster count, a perforation location, a fluid intensity, a temporary plugging agent parameter, a fracturing fluid density parameter, and a discharge rate parameter.

The stage-associated parameter refers to a parameter associated with a fracture stage. In some embodiments, the stage-associated parameters for the Class I fracture stage may include the geomechanical model, etc., the stage-associated parameters for the Class II fracture stage may include the geomechanical model and the natural fracture model, and the stage-associated parameters for the Class III fracture stage may include the geomechanical model, the natural fracture model, and current wellbore data and historical wellbore data corresponding to the Class III fracture stage.

The candidate operation parameters refer to fracturing operation parameters to be determined. In some embodiments, the processor may determine the candidate operation parameters in plurality of ways. For example, the processor may determine fracturing operation parameters as historical data as the candidate operation parameters. As another example, the processor may randomize the fracturing operation parameters in the historical data to obtain the candidate operation parameters.

In some embodiments, the candidate operation parameters include candidate first operation parameters, candidate second operation parameters, and candidate third operation parameters.

The estimated operation data refers to estimated data associated with a fractured fracture around the infill well after operations conducted with the candidate operation parameters. In some embodiments, the estimated operation data may include changes in the fractured fracture over time (e.g., a fracture depth, etc.) and whether or not fracture containment occurs. The estimated operation data may be represented by the geomechanical model.

In some embodiments, the processor may determine the estimated operation data via a fracturing operation model based on the candidate operation parameters, the reservoir property model, the geomechanical model, the fracture stage type, and the stage-associated parameters. The type of the candidate operation parameters input into the fracturing operation model corresponds to the fracture stage type, for example, if the fracture stage type is the Class I fracture stage, the candidate first operation parameters are input into the fracturing operation model.

In some embodiments, the fracturing operation model may be a machine learning model, such as one or a combination of a Recurrent Neural Networks (RNN) model or other customized model structures.

In some embodiments, the processor may train the fracturing operation model with a plurality of second training samples with second labels. A second training sample may include sample operation parameters, a sample reservoir property model, a sample geomechanical model, a sample fracture stage type, and sample stage-associated parameters. A second label includes actual operation data corresponding to the second training sample.

In some embodiments, the second training samples and the second labels may be determined based on historical data. For example, the processor may obtain historical operation parameters, a historical reservoir property model, a historical geomechanical model, a historical fracture stage type, and historical stage-associated parameters at a third historical time in the historical data as the second training sample, and after the fracturing operation of the historical infill well based on the second training sample, the changes of the fractured fracture over time at the fourth historical time and whether or not fracture containment occurs, etc., will be used as the second label. The third historical time is earlier than the fourth historical time.

The training manner for the fracturing operation model is similar to that for the confidence determination model, and is not repeated here.

In some embodiments, for each fracture stage type, the processor may determine the fracturing operation parameters based on the estimated operation data. For example, for each fracture stage type and a plurality of sets of candidate operation parameters corresponding to the fracture stage type, the processor may filter out a set of candidate operation parameters that do not have compression tampering and have the shortest estimated operation time as the fracturing operation parameters corresponding to the fracture stage type based on the estimated operation data corresponding to the plurality of sets of candidate operation parameters.

In some embodiments, the estimated operation time may be determined based on the depth of the fractured fracture in the estimated operation data. For example, the deeper the depth of the fracture, the longer the estimated operation time.

In some embodiments, for the Class I fracture stages, the processor generates a first instruction based on the first operation parameter to: control a perforating gun to perform perforation according to a cluster count specified by the first operation parameter, and control a fracturing pump truck and a pipeline switch valve assembly to inject a fracturing fluid at a fluid intensity specified by the first operation parameter.

The fracturing pump truck is configured to power the fracturing operation. In some embodiments, the fracturing pump truck may include an electric drive pump truck, a turbine pump truck, etc.

The pipeline switch valve assembly is configured to control a flow direction and a discharge volume of the fracturing fluid, and pipeline switching.

In some embodiments, the processor controls the fluid intensity and the discharge volume of the fracturing fluid by controlling a pumping rate of the fracturing pump truck and the opening or closing and an opening percentage of the pipeline switch valve assembly.

In some embodiments, for the Class II fracture stages, the processor generates a second instruction based on the second operation parameter to: control the perforating gun to perform perforation according to a cluster count specified by the second operation parameter, control the fracturing pump truck and the pipeline switch valve assembly to inject the fracturing fluid at a fluid intensity specified by the second operation parameter, and control a temporary plugging agent injection device to inject a temporary plugging agent at a temporary plugging agent parameter specified by the second operation parameter.

The temporary plugging agent refers to a material used to plug a fracture, such as biodegradable polymers, heat-sensitive materials, composite chemical agents, etc.

The temporary plugging agent injection device is configured to inject the temporary plugging agent into the fracturing fluid. In some embodiments, the temporary plugging agent injection device may include an injection pump, an injection pipeline, etc.

In some embodiments, for the Class III fracture stages, the processor generates a third instruction based on the third operation parameter to: control the perforating gun to perform perforation according to a cluster count and a perforation location specified by the third operation parameter, control the fracturing pump truck and the pipeline switch valve assembly to inject the fracturing fluid at a fluid intensity specified by the third operation parameter. The processor controls the temporary plugging agent injection device to inject the temporary plugging agent at a temporary plugging agent parameter specified by the third operation parameter, controls a premixing system to adjust the density of the fracturing fluid according to a fracturing fluid density parameter specified by the third operation parameter, and controls the pipeline switch valve assembly to regulate the discharge volume of the fracturing fluid based on a discharge rate parameter specified by the third operation parameter.

The premixing system is configured to mix to obtain the fracturing fluid. In some embodiments, the premixing system may include an automated sand mixing truck with a controller, a mixing tank, etc.

In some embodiments, the premixing system (e.g., the automated sand mixing truck with a controller) stores a third preset table, and the premixing system may query, based on the fracturing fluid density parameter specified by the third operation parameter, the third preset table for a material mixing ratio that corresponds to the density of the fracturing fluid, and obtain the fracturing fluid by mixing based on the material mixing ratio. The material mixing ratio includes a mixing ratio of water, soil, and chemicals.

In some embodiments, the third preset table may be determined based on a manual predetermination, including a plurality of correspondences between a density of the fracturing fluid and a material mixing ratio.

In some embodiments, the perforating gun, the fracturing pump truck and the pipeline switch valve assembly, the temporary plugging agent injection device, and the premixing system may be communicatively coupled to the processor.

In some embodiments of the present disclosure, by performing different fracturing operations on different types of fracture stages, parameter control may be targeted and simplified while ensuring the safety of the fracturing operations, thereby reducing the duration of the work period and reducing the cost of the fracturing operations.

In some embodiments, during the fracturing operation, the processor may obtain operation monitoring data and assess a fracture containment risk based on the operation monitoring data and the fracture stage type.

In some embodiments, in response to the fracture containment risk meeting a risk condition, the processor issues an alarm and adjusts the fracturing operation parameters for a subsequent fracture stage, includes: generating an adjustment instruction based on the adjusted fracturing operation parameters, and transmitting the adjustment instruction to the fracturing pump truck to regulate the pumping rate, the pipeline switch valve assembly to control the opening percentage, and the temporary plugging agent injection device to adjust a temporary plugging agent dosage.

The operation monitoring data refers to data that monitors the operation. In some embodiments, the operation monitoring data includes acoustic signals, wellhead pressures, and well temperatures at a plurality of time points. The plurality of time points may be preset based on historical experience.

In some embodiments, the acoustic signals include acoustic signals of the infill well and acoustic signals of a neighboring well. The wellhead pressure includes a wellhead pressure of the infill well and a wellhead pressure of the neighboring well. The well temperature includes a temperature of the infill well and a temperature of the neighboring well. The neighboring well refers to a well adjacent to the infill well.

In some embodiments, the processor may acquire acoustic signals via distributed acoustic sensing optical fibers disposed on the outer wall of the wellbore or within the wellbore of the infill well and the neighboring well, respectively. The processor may obtain wellhead pressures via pressure sensors disposed at the wellhead of the infill well and the wellhead of the neighboring well, respectively. The processor may obtain well temperatures via distributed temperature sensing optical fibers disposed on the outer wall of the wellbore or within the wellbore of the infill well and the neighboring well, respectively.

The fracture containment risk may be a possibility that a fracture containment occurs during the fracturing operation. In some embodiments, the fracture containment risk may be expressed by a numerical value, where the greater the value, the greater the possibility that the fracture containment occurs during the fracturing operation.

In some embodiments, the processor may determine the fracture containment risk based on the operation monitoring data and the fracture stage type, for example, the processor may determine a judgment rule based on the fracture stage type, and determine the fracture containment risk based on the operation monitoring data and the judgment rule.

Exemplarily, the processor may preset an initial value of the fracture containment risk to be 0, add a value to the fracture containment risk based on the judgment rule, and obtain a final fracture containment risk.

In some embodiments, the judgment rule may be preset based on historical experience. For example, if the broadband energy of the acoustic signal from a neighboring well at a given time point is greater than three times the broadband energy of the background noise (e.g., noise generated by a construction device), the fracture containment risk is increased by 30. As another example, if the downward gradient of the wellhead pressure of the infill well is greater than −1 MPa/min, the processor increases the fracture containment risk by 20.

In some embodiments, the judgment rules are different for different fracture stage types. For example, for different fracture stage types, the judgment rule assigns different values to the increase in the fracture containment risk.

The risk condition refers to a condition that determines whether an alarm needs to be issued and to adjust the fracturing operation parameters for the subsequent fracture stage. In some embodiments, the risk condition may be that the fracture containment risk is greater than a fracture containment risk threshold. The fracture containment risk threshold may be preset based on historical experience.

In some embodiments, the fracture containment risk includes both meeting the risk condition and not meeting the risk condition. In response to the fracture containment risk meeting the risk condition, the processor issues the alarm and adjusts the fracturing operation parameters for the subsequent fracture stage. The alarm may be indicated by sound or text, and the text alarm is sent by the processor to the user terminal over the network. The user terminal may be a device used by technicians (e.g., operators, etc.), such as a computer, etc.

In some embodiments, in response to the fracture containment risk not meeting the risk condition, the processor does not operate.

In some embodiments, the processor may re-determine the fracturing operation parameters for the subsequent fracture stage based on the candidate operation parameters, for which refer to the above and related description thereof.

In some embodiments, the alarm may be categorized into a plurality of levels, with each level corresponding to a type of processing. For example, if the fracture containment risk is greater than a first risk threshold and less than a second risk threshold, the processor may issue a level 1 alarm to a technician to temporarily not adjust the fracturing operation parameters for the subsequent fracture stage. For example, if the fracture containment risk is greater than the second risk threshold and less than a third risk threshold, the processor may issue a level 2 alarm and adjusted fracturing operation parameters to the technician, and generate an adjustment instruction based on the fracturing operation parameters confirmed by the technician, and send the adjustment instruction to the fracturing pump truck, the pipeline switch valve assembly, and the temporary plugging agent injection device. If the fracture containment risk is greater than the third risk threshold, the processor may send a level 3 alarm to the technician and trigger an automatic protection program.

In some embodiments, the automatic protection program may include controlling the fracturing pump truck to reduce the fluid intensity to a minimum safe value or controlling the pipeline switch valve assembly to close and wait for a manual instruction. The minimum safety value may be determined based on an experience.

In some embodiments, if the manual instruction is to stop pumping, the processor may control a high-pressure plug valve mounted at a critical node of a high-pressure pipeline manifold that conveys the fracturing fluid to perform pump shutdown. For example, the processor may control the high-pressure plug valve to simultaneously close all valves of pumps that are connected to a main pipeline while simultaneously opening a pressure relief valve to a backup liquid storage tank to achieve a quick and safe pump shutdown. The critical node may include pump outlets, main pipelines, branch diversion points, etc. The backup liquid storage tank refers to a backup storage device for storing the fracturing fluid.

In some embodiments of the present disclosure, by setting different risk conditions, it is possible to execute reasonable countermeasures for different fracture containment risks, and monitor the condition of the fracking operation in real time, so as to ensure that the fracking operation is conducted safely.

In some embodiments, the present disclosure further provides a system for fracturing design of an infill well based on a recoverable region, includes:
a model construction module configured to construct a fracturing parameter design model for an infill well in a target block;
a production process simulation module configured to simulate a production process of an implemented well pattern based on the infill well fracturing parameter design model, and obtain a pressure field of the infill well before fracturing;
a four-dimensional stress dynamics calculation module configured to perform four-dimensional stress dynamics calculation during a hydrocarbon reservoir production process based on the pressure field to obtain a stress evolution result, and update relevant geological parameters in the fracturing parameter design model for the infill well according to the stress evolution result;
an area calculation module configured to identify an area of a recoverable region of the infill well in an updated fracturing parameter design model; and
a fracturing operation parameter design module configured to perform staged fracturing classification for the infill well based on the area of the recoverable region, and design differentiated fracturing operation parameters for classified multi-stage fractures.

In some embodiments, the present disclosure further provides an electronic device, includes a memory and a processor, wherein the memory is configured to store computer programs, the processor runs the computer programs to cause the electronic device to implement the method for fracturing design of an infill well based on a recoverable region according to above embodiments.

In some embodiments, the present disclosure further provides a non-transitory computer-readable storage medium storing computer programs, wherein the computer programs are executed by a processor to implement the method for fracturing design of an infill well based on a recoverable region according to above embodiments.

In a specific embodiment, taking an intermediate-depth shale gas reservoir platform as an example, an infill well fracturing design is performed based on the method for fracturing design of an infill well based on a recoverable region described in the present disclosure, which includes the following steps.

(1) Constructing a fracturing parameter design model for an infill well in a target block.

In this embodiment, a three-dimensional geomechanical model of a well group region containing reservoir properties and geomechanical parameters is established for the well group H15 of the platform, and a fracturing well pattern of the implemented parent wells is constructed on the three-dimensional geomechanical model of the well group region, and a fracturing parameter design model is obtained. Specifically, a reservoir property model and a geomechanical model are constructed based on porosity, permeability, saturation, Young's modulus, Poisson's ratio, triaxial principal stresses, stress orientation, and pore pressure of a single well in the H well group. A natural fracture model is constructed based on the fracture distribution, fracture dimension, fracture orientation, etc. A parent well pattern model is constructed based on parent well trajectories and simulated fracture network results.

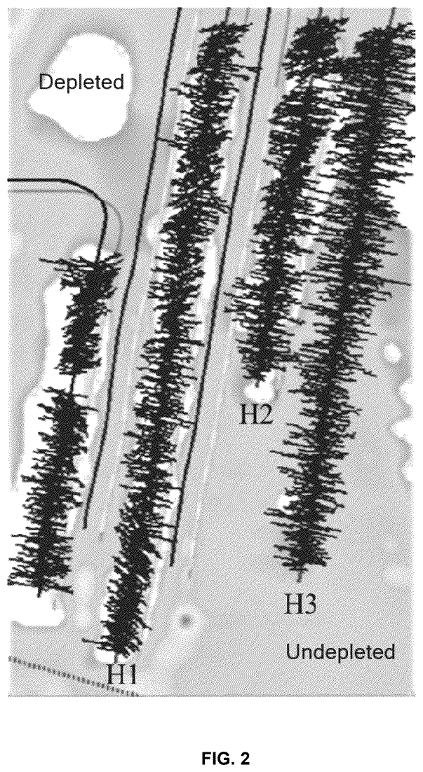

FIG. 2 is a comparative verification diagram of a simulated fracture network and the monitoring results obtained using a holographic electromagnetic manner in a specific embodiment.

In some embodiments, the simulation of the fracture network of the parent well takes into account the effect of natural fracture prediction and fracture regions and is fitted to the monitoring result of the holographic electromagnetic manner, and a calibration result is shown in FIG. 2.

(2) Simulating a production process of an implemented well pattern based on the fracturing parameter design model of the infill well, and obtaining a pressure field of the infill well before fracturing.

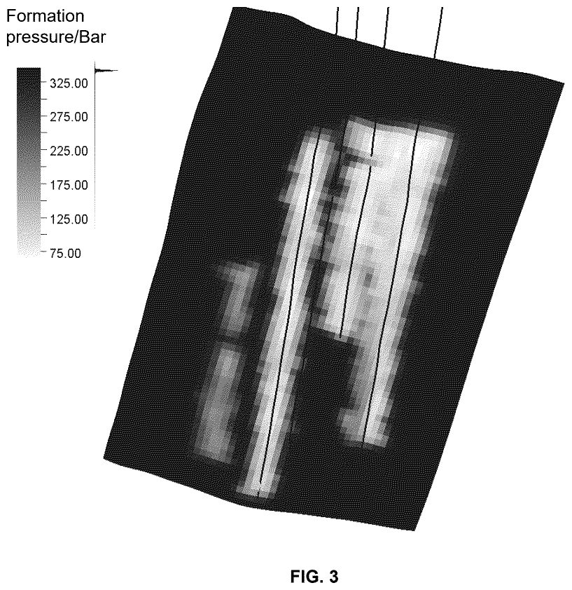

FIG. 3 is a pressure field diagram of an infill well before fracturing in a specific embodiment.

In this embodiment, based on the fracturing parameter design model for the infill well of the platform H constructed in step (1), the processor fits the production dynamic data of the implemented well pattern (including three mother wells, H-1, H-2 and H-3) to simulate the pressure field of the infill well before fracturing, and the results are shown in FIG. 3.

(3) Performing four-dimensional stress dynamics calculation during a hydrocarbon reservoir production process based on the pressure field to obtain a stress evolution result, and updating relevant geological parameters in the fracturing parameter design model for the infill well according to the stress evolution result.

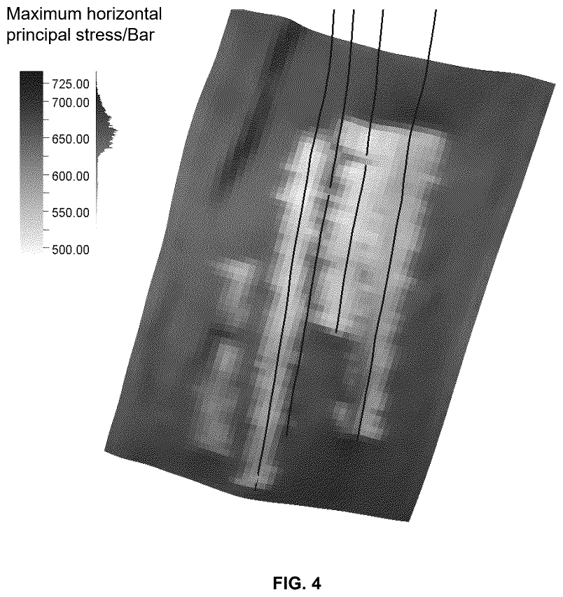

FIG. 4 is an updated distribution map of a maximum horizontal principal stress in a specific embodiment.

In some embodiments, the updated distribution of the maximum horizontal principal stress is shown in FIG. 4.

(4) Identifying an area of a recoverable region of the infill well in an updated fracturing parameter design model.

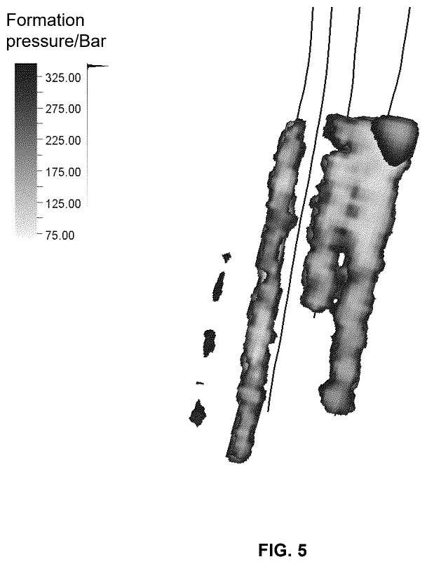

FIG. 5 is a schematic diagram of a depleted region in a specific embodiment.

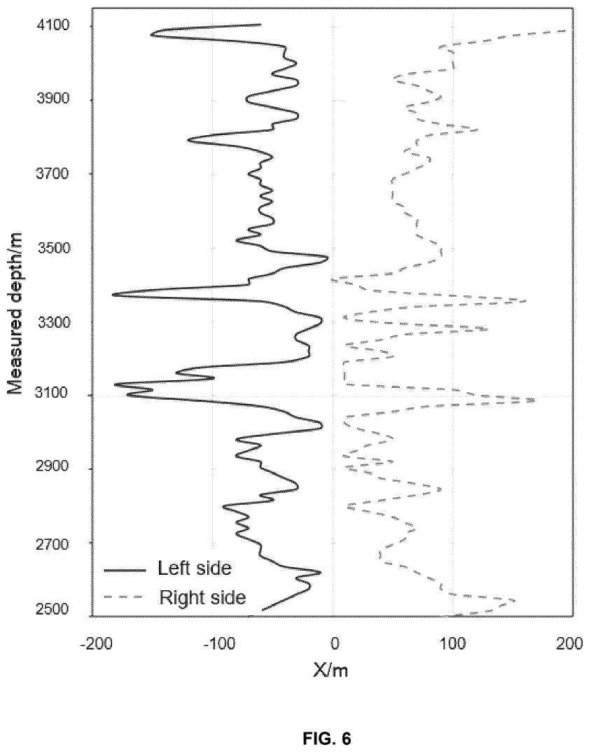

FIG. 6 is a schematic diagram of a boundary of the recoverable region on both sides drawn based on pressure depletion in a specific embodiment.

In this embodiment, the depleted region of the infill well group is identified and mapped using a pressure depletion threshold of 10% as a boundary, and the results are shown in FIG. 5. The results of the areas of the recoverable regions on the left and right sides of the infill well are shown in FIG. 6.

(5) Performing staged fracturing classification for the infill well based on the area of the recoverable region, and designing differentiated fracturing operation parameters for classified multi-stage fractures.

In this embodiment, taking platform H as an example, a distance S between wells H-1 and H-2 is 400 m, and an infill well H-J is located between the wells H-1 and H-2, and well H-3 is located on the right side of the well H-2. Keeping the total operation scale of the infill well unchanged, the fracture stage is staggered with the parent wells, and the segmentation results are as follows:
a fracture stage is classified as Class I fracture stage when: a total recoverable length on both sides of a horizontal fracture stage is larger than or equal to 0.5 times a parent well spacing, and distances from the both sides of the horizontal fracture stage to a boundary of the recoverable region are each larger than or equal to 0.9 times a well spacing;
a fracture stage is classified as Class II fracture stage when: a total recoverable length on both sides of a horizontal fracture stage is larger than or equal to 0.5 times the parent well spacing, and distances from the both sides of the horizontal fracture stage to the boundary of the recoverable region are each larger than or equal to 0.1 times the well spacing; and
a fracture stage is classified as Class III fracture stage when: a total recoverable length on both sides of a horizontal fracture stage is less than 0.5 times the parent well spacing, and distances from the both sides of the horizontal fracture stage to the boundary of the recoverable region are each larger than or equal to 0.1 times the well spacing.

In some other embodiments, the segmentation results are as follows:
a fracture stage is classified as Class I fracture stage when: the total recoverable length L on both sides of the horizontal fracture stage is greater than or equal to 0.5 S (i.e., 200 m) and distances from the both sides of the horizontal fracture stage to the boundary of the recoverable region are less than 0.1 L (i.e., 20 m);
a fracture stage is classified as Class II fracture stage when: the total recoverable length L on both sides of the horizontal fracture stage is less than 0.5 S and distances from the both sides of the horizontal fracture stage to the boundary of the recoverable region are less than 0.1 L;
a fracture stage is classified as Class III fracture stage when: the total recoverable length L on both sides of the horizontal fracture stage is less than 0.5 S and distances from the both sides of the horizontal fracture stage to the boundary of the recoverable region are greater than 0.1 L.

In some embodiments, differentiated optimized designs (also referred to as differentiated fracturing operation parameter designs) are performed for different classes of fracture stages: the Class I fracture stage have larger recoverable regions on both sides, and to maximize a stimulated reservoir volume, 8 clusters of perforations are used, with a fluid intensity range of 27-30 m³/m. The difference between the recoverable regions on both sides of the class II fracture stage is large, there is a certain fracture containment risk, and 10 clusters of perforations are used, with a fluid intensity range of 22-25 m³/m, which is used in temporary plugging to enhance the effect of the transformation. The Class III fracture stage has a limited recoverable region and a high fracture containment risk, so it is necessary to cooperate with the temporary plugging to ensure fracture containment, and adopt 11 clusters of perforations, with the fluid intensity not more than 21 m³/m, which is adjusted differently according to the size of the recoverable region.

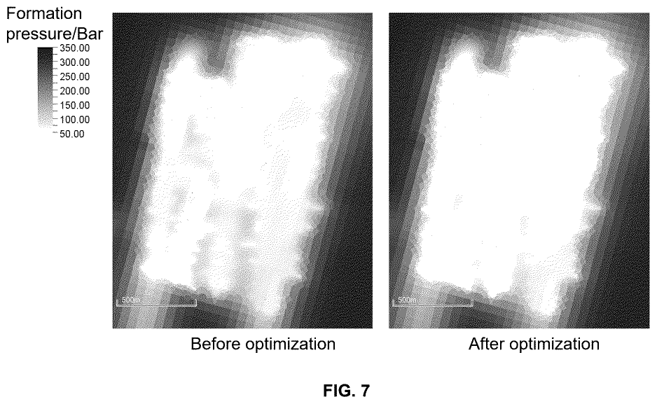

FIG. 7 is a diagram of pre-optimization (left) and post-optimization (right) pressure fields at a final production stage of a well group in a specific embodiment, where the left side represents the state before optimization and the right side represents the state after optimization.

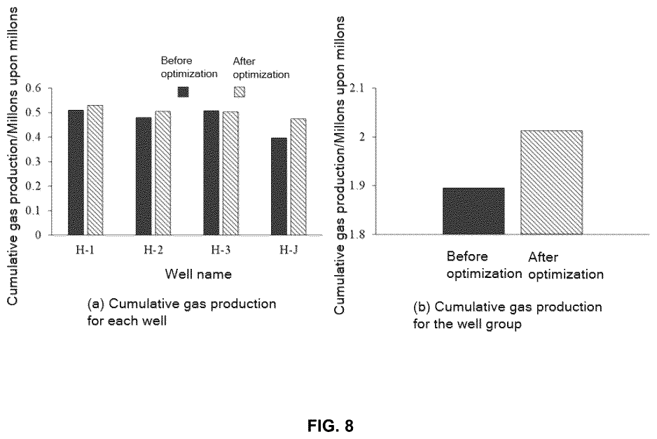

FIG. 8 is a comparative diagram of cumulative gas productions of a well group before and after optimization in a specific embodiment, wherein FIG. 8(a) is a comparative diagram of cumulative gas productions for each well, and FIG. 8(b) is a comparative diagram of cumulative gas productions for the well group.

In some embodiments, pre-optimization (left) and post-optimization (right) pressure fields at the final production stage of the infill well H-J after fracturing are shown in FIG. 7. The comparison of cumulative gas productions for each well in the well group is shown in FIG. 8. Referring to FIG. 8, it may be seen that compared with the original scheme, the optimized scheme increases the gas production of the infill well H-J while the production capacity of the parent wells is also restored, which improves the overall gas production of the well group.

In summary, the present disclosure can identify the recoverable region of the infill well, and carry out a more refined differential fracturing design of the infill well, which improves the fracturing effect of the infill well while avoiding fracture containment, and increases the overall production capacity of the infill well group. Compared with the prior art, the present disclosure has significant progress.

The present disclosure can simulate and analyze the unevenly reformed the depleted region of implemented shale gas wells, and launch the optimized design of the infill well for fracturing based on the remaining recoverable region, which avoids compression tampering while improving the effect of the infill well for fracturing, and increases the overall production capacity of the infill well group.

The foregoing is only a preferred embodiment of the present disclosure, and is not a limitation of the present disclosure in any way, and although the present disclosure has been disclosed as such by way of a preferred embodiment, it is not intended to be a limitation of the present disclosure, and any skilled person familiar with the art will, without departing from the technical solutions of the present disclosure, be able to use the present disclosure in a manner that is not inconsistent with the technical solutions of the present disclosure. Any skilled person familiar with the technology of the present disclosure, within the scope of the technical program of the present disclosure, when the technical content of the above disclosure may be used to make some changes or modifications for equivalent changes in the equivalent embodiment, but not out of the content of the technical program of the present disclosure, based on the technical substance of the present disclosure of the above embodiment made any simple modifications, equivalent changes and modifications, are still within the scope of the technical program of the present disclosure.

What is claimed is:

1. A method for fracturing design of an infill well based on a recoverable region, comprising:
S1: constructing a fracturing parameter design model for an infill well in a target block;
S2: simulating a production process of an implemented well pattern based on the fracturing parameter design model of the infill well, and obtaining a pressure field of the infill well before fracturing;
S3: performing four-dimensional stress dynamics calculation during a hydrocarbon reservoir production process based on the pressure field to obtain a stress evolution result, and updating relevant geological parameters in the fracturing parameter design model for the infill well according to the stress evolution result;
S4: identifying an area of a recoverable region of the infill well in an updated fracturing parameter design model; and
S5: performing staged fracturing classification for the infill well based on the area of the recoverable region, and designing differentiated fracturing operation parameters for classified multi-stage fractures; wherein
criteria for performing staged fracturing classification for the infill well are as follows:
a fracture stage is classified as Class I fracture stage when: a total recoverable length on both sides of a horizontal fracture stage is larger than or equal to 0.5 times a parent well spacing, and distances from the both sides of the horizontal fracture stage to a boundary of the recoverable region are each larger than or equal to 0.9 times a well spacing;
a fracture stage is classified as Class II fracture stage when: a total recoverable length on both sides of a horizontal fracture stage is larger than or equal to 0.5 times the parent well spacing, and distances from the both sides of the horizontal fracture stage to the boundary of the recoverable region are each larger than or equal to 0.1 times the well spacing;
a fracture stage is classified as Class III fracture stage when: a total recoverable length on both sides of a horizontal fracture stage is less than 0.5 times the parent well spacing, and distances from the both sides of the horizontal fracture stage to the boundary of the recoverable region are each larger than or equal to 0.1 times the well spacing;
when designing the differentiated fracturing operation parameters for the classified multi-stage fractures,
for Class I fracture stages, designing the differentiated fracturing operation parameters to maximize a stimulated reservoir volume (SRV);
for Class II fracture stages, designing the differentiated fracturing operation parameters in combination with temporary plugging; and
for Class III fracture stages, designing the differentiated fracturing operation parameters primarily for fracture containment.

2. The method according to claim 1, wherein in S1, the fracturing parameter design model for the infill well includes a reservoir property model, a geomechanical model, a natural fracture model, and a parent well pattern model.

3. The method according to claim 2, wherein the reservoir property model includes porosity, permeability, and saturation; the geomechanical model includes Young's modulus, Poisson's ratio, triaxial principal stresses, stress orientation, and pore pressure; the natural fracture model includes fracture distribution, fracture dimension, and fracture orientation; and the parent well pattern model includes parent well trajectories and simulated fracture network results.

4. The method according to claim 1, wherein S2 further includes: obtaining historical production data of the implemented well pattern; calibrating a simulated production process using the historical production data to obtain a calibration result; and adjusting the fracturing parameter design model for the infill well based on the calibration result.

5. The method according to claim 1, wherein S4 further includes: identifying depleted boundaries of two nearest parent wells relative to the infill well using a pressure depletion threshold; a region between the depleted boundaries of the two parent wells being an undepleted region; and calculating the area of the recoverable region of the infill well based on the undepleted region.

6. The method according to claim 1, wherein the identifying an area of a recoverable region of the infill well in an updated fracturing parameter design model further includes:
determining a confidence map of the target block based on current wellbore data, historical wellbore data, a natural fracture model, a reservoir property model, and a geomechanical model; and
determining, based on the confidence map, the recoverable region of the infill well and the area of the recoverable region of the infill well.

7. The method according to claim 6, comprising:
determining a production difficulty based on the historical wellbore data, the natural fracture model, the reservoir property model, and the geomechanical model;
determining a confidence threshold based on the production difficulty; and
determining the recoverable region of the infill well and the area of the recoverable region of the infill well based on the confidence threshold and the confidence map.

8. The method according to claim 1, wherein designing the differentiated fracturing operation parameters for the classified multi-stage fractures includes:
determining estimated operation data based on candidate operation parameters, a reservoir property model, a geomechanical model, a fracture stage type, and stage-associated parameters;
determining fracturing operation parameters for the multi-fracture stages based on the estimated operation data, wherein the fracturing operation parameters include a first operation parameter, a second operation parameter, and a third operation parameter;
for the Class I fracture stages, generating a first instruction based on the first operation parameter to: control a perforating gun to perform perforation according to a cluster count specified by the first operation parameter; and control a fracturing pump truck and a pipeline switch valve assembly to inject a fracturing fluid at a fluid intensity specified by the first operation parameter;
for the Class II fracture stages, generating a second instruction based on the second operation parameter to: control the perforating gun to perform perforation according to a cluster count specified by the second operation parameter, control the fracturing pump truck and the pipeline switch valve assembly to inject the fracturing fluid at a fluid intensity specified by the second operation parameter, and control a temporary plugging agent injection device to inject a temporary plugging agent at a temporary plugging agent parameter specified by the second operation parameter; and
for the Class III fracture stages, generating a third instruction based on the third operation parameter to: control the perforating gun to perform perforation according to a cluster count and a perforation location specified by the third operation parameter;
control the fracturing pump truck and the pipeline switch valve assembly to inject the fracturing fluid at a fluid intensity specified by the third operation parameter, control the temporary plugging agent injection device to inject the temporary plugging agent at a temporary plugging agent parameter specified by the third operation parameter, control a premixing system to adjust a density of the fracturing fluid according to a fracturing fluid density parameter specified by the third operation parameter, and control the pipeline switch valve assembly to regulate a discharge volume of the fracturing fluid based on a discharge rate parameter specified by the third operation parameter.

9. The method according to claim 1, comprising:
obtaining operation monitoring data via a sensing device during a fracturing operation;
assessing a fracture containment risk based on the operation monitoring data and a fracture stage type; and
in response to the fracture containment risk meeting a risk condition, issuing an alarm, and adjusting the fracturing operation parameters for a subsequent fracture stage by:
generating an adjustment instruction based on the adjusted fracturing operation parameters; and transmitting the adjustment instruction to a fracturing pump truck to regulate a pumping rate, a pipeline switch valve assembly to control an opening percentage, and a temporary plugging agent injection device to adjust a temporary plugging agent dosage.

10. A system for fracturing design of an infill well based on a recoverable region, comprising:
a model construction module configured to construct a fracturing parameter design model for an infill well in a target block;
a production process simulation module configured to simulate a production process of an implemented well pattern based on the fracturing parameter design model for the infill well, and obtain a pressure field of the infill well before fracturing;
a four-dimensional stress dynamics calculation module configured to perform four-dimensional stress dynamics calculation during a hydrocarbon reservoir production process based on the pressure field to obtain a stress evolution result, and update relevant geological parameters in the fracturing parameter design model for the infill well according to the stress evolution result;
an area calculation module configured to identify an area of a recoverable region of the infill well in an updated fracturing parameter design model; and
a fracturing operation parameter design module configured to perform staged fracturing classification for the infill well based on the area of the recoverable region, and design differentiated fracturing operation parameters for classified multi-stage fractures; wherein
criteria for performing staged fracturing classification for the infill well are as follows:
a fracture stage is classified as Class I fracture stage when: a total recoverable length on both sides of a horizontal fracture stage is larger than or equal to 0.5 times a parent well spacing, and distances from the both sides of the horizontal fracture stage to a boundary of the recoverable region are each larger than or equal to 0.9 times a well spacing;
a fracture stage is classified as Class II fracture stage when: a total recoverable length on both sides of a horizontal fracture stage is larger than or equal to 0.5 times the parent well spacing, and distances from the both sides of the horizontal fracture stage to the boundary of the recoverable region are each larger than or equal to 0.1 times the well spacing;
a fracture stage is classified as Class III fracture stage when: a total recoverable length on both sides of a horizontal fracture stage is less than 0.5 times the parent well spacing, and distances from the both sides of the horizontal fracture stage to the boundary of the recoverable region are each larger than or equal to 0.1 times the well spacing;
when designing the differentiated fracturing operation parameters for the classified multi-stage fractures,
for Class I fracture stages, designing the differentiated fracturing operation parameters to maximize a stimulated reservoir volume (SRV);
for Class II fracture stages, designing the differentiated fracturing operation parameters in combination with temporary plugging; and
for Class III fracture stages, designing the differentiated fracturing operation parameters primarily for fracture containment.

11. An electronic device, comprising a memory and a processor, wherein the memory is configured to store computer programs, the processor runs the computer programs to cause the electronic device to implement the method for fracturing design of an encrypted well based on a movable region according to claim 1.

12. A non-transitory computer-readable storage medium storing computer programs, wherein the computer programs are executed by a processor to implement the method for fracturing design of an infill well based on a recoverable region according to claim 1.
